(19) United States
(12) Patent Application Publication
(10) Pub. No.: US 2013/0211545 A1
(43) Pub. Date: Aug. 15, 2013

(54) Embedded Multi-Processor Parallel Processing System and Operating Method for Same

(71) Applicants: Ming JIE, Beijing (CN); Fei Long, Beijing (CN); Li Pan, Beijing (CN)

(72) Inventors: Ming JIE, Beijing (CN); Fei Long, Beijing (CN); Li Pan, Beijing (CN)

(73) Assignee: Siemens Aktiengesellschaft, Muenchen (DE)

(21) Appl. No.: 13/572,396

(22) Filed: Aug. 10, 2012

(30) Foreign Application Priority Data
Aug. 11, 2011 (CN) 201110229856.2

(51) Int. Cl. G05B 19/042

(52) U.S. Cl. CPC G05B 19/0421
USPC 700/4

(57) ABSTRACT

An embedded multi-processor parallel processing system includes a compilation unit, an operational support unit and at least two processing units, and an operating method for the embedded multi-processor parallel processing system, wherein the embedded multi-processor parallel processing system and system operating method provide parallel processing by multiple processing units on an embedded hardware platform.

### BACKGROUND OF THE INVENTION

1. Field of the Invention

The present invention relates to the field of automatic controls and, more particularly, to an embedded multi-processor parallel processing system and an operating method for the same.

2. Description of the Related Art

In general, automatic control systems are used to process automated tasks within a certain range. When the tasks to be processed by an automatic control system exceed the capacity and processing capability of the system, it is necessary to update the system, i.e., upgrade the system's capacity, processing capability and performance, in order to attain a level at which the system demands can be satisfied. The traditional way of updating an automatic control system is to replace the original system with a higher-grade system with a larger capacity and better processing capability, and thereby meet the requirements of the system update. Such an update, which relies on substitution of equipment, will be accompanied by problems of high cost and complicated operation.

FIG. 1 is a structural schematic block diagram of a Multi-Processor Parallel Controlling System (MPPCS), where the MPPCS can execute multiple program instructions and data simultaneously on multiple processors to obtain a faster operating result. The multi-processor parallel control system shown in FIG. 1 comprises N processing units (abbreviated as PU, Process Unit or referred to as a unit controller) from processing unit 1 to processing unit N, one compiler (for example, HMI or PG/Compiler), and an interconnected network connected to the N processing units and the compiler. The N processing units are for executing in parallel the programs to be executed by the automatic control system, i.e., each processing unit executes part of the programs to be executed by the automatic control system. The compiler is connected to the N processing units via the interconnected network, and is used to convert a serial automatic control program described in engineering language into parallel code executed on multiple processing units simultaneously, thereby ensuring that the processing units are able to execute parallel tasks. The N processing units are connected via the interconnected network, with the result that information on one processing unit can be transferred to another processing unit via the interconnected network. Compared to the method of upgrade by substitution, because a multi-processor parallel control system only requires the addition of new modules or equipment, taking the original system as a basis, upgrades can be performed more quickly and easily, on the one hand, while expenditure and the cost of upgrading the system are reduced, on the other hand.

However, different embedded hardware platforms (such as Associate in Risk Management (ARM) or Microprocessor without Interlocked Pipeline Stages (MIPS)) have different instruction sets. As a result, it is difficult to set up a universal software operating platform for embedded hardware platforms. Although a Java virtual machine can provide a universal software operating platform for different hardware platforms, the excessively large size of the Java virtual machine and the relatively low execution efficiency thereof mean that it is not suited for use with embedded hardware platforms and, thus, at the present time there is no MPPCS applicable to embedded hardware platforms.

### SUMMARY OF THE INVENTION

It is therefore an object of the invention to provide an embedded multi-processor parallel processing system for realizing parallel processing by multiple processing units on an embedded hardware platform.

This and other objects and advantages are achieved in accordance with the invention by an embedded multi-processor parallel processing system, including:

a compilation unit for generating a plurality of automatic control subroutines according to an automatic control program, and for compiling each of the automatic control subroutines into intermediate code;

an operational support unit for acquiring the intermediate code of each of the automatic control subroutines from the compilation unit and converting the intermediate code of each of the automatic control subroutines to tasks to be run in an embedded operating system, and for identifying each processing unit and sending each of the tasks to the corresponding processing unit; and

at least two processing units for receiving and running the tasks obtained through conversion of the intermediate code of the automatic control subroutines and sent by the operational support unit, and capable of performing data communication with each other while running the tasks corresponding to the automatic control subroutines.

In an embodiment of the above system of the invention, a multi-processor parallel processing system can be realized on an embedded hardware platform by having a compilation unit generate a plurality of automatic control subroutines according to an automatic control program and then convert each automatic control subroutine to intermediate code, after which an operational support unit converts the intermediate code to tasks to be run in an embedded operating system and sends the tasks to corresponding processing units, with the processing units performing data interaction with each other while running their respective tasks. The processing efficiency is thus improved, and new functions can be added when necessary simply by adding corresponding processing units.

The operational support unit is further used to control the at least two processing units to synchronously execute each task obtained through conversion of the intermediate code of each automatic control subroutine.

The automatic control program processed by the compilation unit is at least any one of a structured text language program, a ladder diagram language program, and a function block diagram language program.

The operational support unit is used to perform data communication based on the communication protocol adopted by the operational support unit when at least two processing units are running tasks corresponding to automatic control subroutines, where the communication protocol adopted by the operational support unit comprises at least one of network protocol and data transmission protocol.

The compilation unit comprises a parallelization sub-unit and a compilation sub-unit, where the parallelization sub-unit is for dividing the automatic control program into segments and generating a symbol table, syntax tree and control flow graph based on semantic analysis, and generating a plurality of automatic control subroutines after determining the dependence relationships among the automatic control program segments, and where the compilation sub-unit is for compiling each automatic control subroutine into intermediate code.

The compilation unit further comprises a pre-processing sub-unit, for outputting the automatic control program into an awl format file.

It is also an object of the invention to provide an operating method for an embedded multi-processor parallel control system proposed by the present invention, comprising:

a compilation unit generating a plurality of automatic control subroutines according to an automatic control program, and compiling each of the automatic control subroutines into intermediate code;

an operational support unit acquiring the intermediate code of each of the automatic control subroutines and converting the intermediate code of each of the automatic control subroutines to tasks to be run in an embedded operating system, and after identifying each processing unit, sending each of the tasks to the corresponding processing unit; and

at least two processing units separately receiving the tasks sent by the operational support unit which correspond to the automatic control subroutines and running/executing the same, and performing data communication with each other when running/executing.

In an embodiment of the operating method in accordance with the invention, operation of a multi-processor parallel processing system can be realized on an embedded hardware platform by having a compilation unit generate a plurality of automatic control subroutines according to an automatic control program and then convert each automatic control subroutine to intermediate code, after which an operational support unit converts the intermediate code to tasks to be run in an embedded operating system and sends the same to corresponding processing units, with the processing units performing data interaction while running each of the tasks. The processing efficiency is thus improved, and new functions can be added when necessary simply by adding corresponding processing units.

When the at least two processing units run the tasks corresponding to the automatic control subroutines, the operational support unit controls the at least two processing units to synchronously execute each task obtained through conversion of the intermediate code of each automatic control subroutine.

The automatic control program is at least any one of a structured text language program, a ladder diagram language program, and a function block diagram language program.

The processing units perform data communication with each other based on the communication protocol adopted by the operational support unit, where the communication protocol adopted by the operational support unit comprises at least one of network protocol and data transmission protocol.

The step of generating a plurality of automatic control subroutines according to an automatic control program comprises dividing the automatic control program into segments and generating a symbol table, syntax tree and control flow graph based on semantic analysis, and generating a plurality of automatic control subroutines after determining the dependence relationships among the automatic control program segments.

Before a plurality of automatic control subroutines are generated according to an automatic control program, the automatic control program is output into an awl format file.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred embodiments of the present invention will be described in detail below with reference to the accompanying drawings, so that those skilled in the art may have a clearer understanding of the above and other features and advantages of the present invention, in which:

FIG. 1 is a structural schematic diagram of a multi-processor parallel control system in accordance with the prior art;

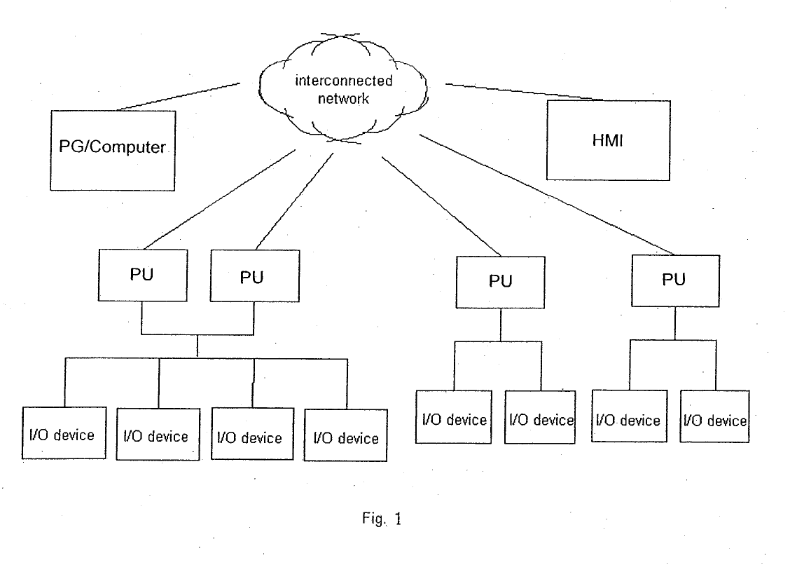

FIG. 2 is a schematic block diagram illustrating the structure of the embedded multi-processor parallel control system in accordance with embodiments of the present invention;

FIG. 3 is a schematic block diagram illustrating the structure of the compilation unit in accordance with embodiments of the present invention;

FIG. 4 is a flow diagram of the operating method for the embedded multi-processor parallel control system in accordance with the embodiments of present invention;

FIG. 5 is a structural schematic block diagram of a specific embedded multi-processor parallel control system in accordance with embodiments of the present invention; and

FIG. 6 is a flow diagram of the operation of a specific processor in accordance with embodiments of the present invention.

### DETAILED DESCRIPTION OF THE PREFERRED EMBODIMENTS

Preferred embodiments of the present invention will be described in detail below with reference to the accompanying drawings.

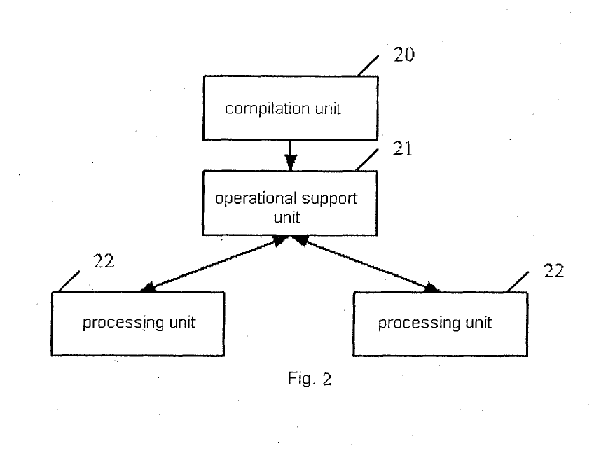

As shown in FIG. 2, an embedded multi-processor parallel control system in accordance with embodiments of the present invention principally comprises a compilation unit 20, an operational support unit 21 and at least two processing units 22, where the compilation unit 20 generates a plurality of automatic control subroutines according to an automatic control program, and compiles each automatic control subroutine into intermediate code, the operational support unit 21 acquires the intermediate code of each of the automatic control subroutines from the compilation unit 20 and converts the intermediate code of each of the automatic control subroutines to tasks to be run in an embedded operating system, and identifies each processing unit 22 and sends each of the tasks to the corresponding processing unit 22, and the at least two processing units 22 receive and run/execute the tasks obtained through conversion of the intermediate code of the automatic control subroutines and sent by the operational support unit 21, and perform data communication amongst the processing units 22 while the tasks corresponding to the automatic control subroutines are running/executing.

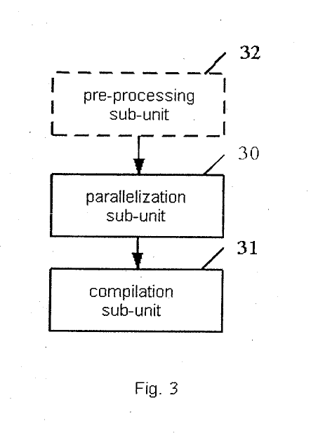

As shown in FIG. 3, the compilation unit 20 principally comprises a parallelization sub-unit 30 and a compilation sub-unit 31, where the parallelization sub-unit 30 divides the automatic control program into segments and generates a symbol table, syntax tree and control flow graph based on semantic analysis, and generates a plurality of automatic control subroutines after determining the dependence relationships among the automatic control program segments, and the compilation sub-unit 31 compiles each automatic control subroutine into intermediate code.

The compilation unit 20 may further comprise a pre-processing sub-unit 32 for outputting the automatic control program into an awl format file.

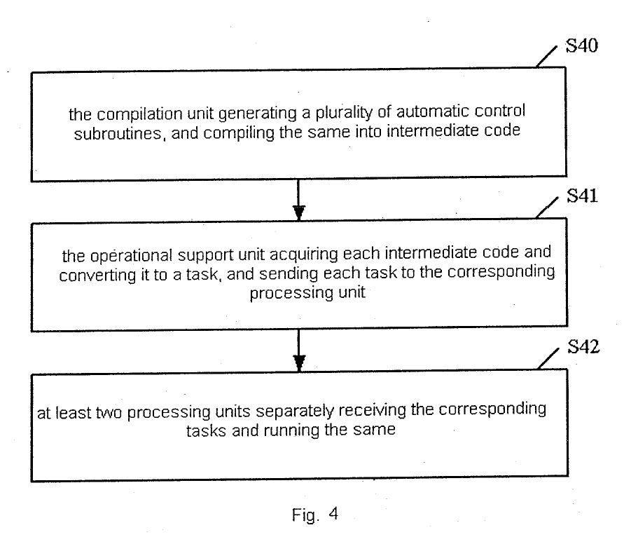

On the basis of the above system architecture, as shown in FIG. 4, the detailed flow process of the operating method for the embedded multi-processor parallel control system is as follows:

Step S40: the compilation unit generates a plurality of automatic control subroutines according to an automatic control program, and compiles each of the automatic control subroutines into intermediate code.

The automatic control program is at least any one of a structured text language (STL) program, a ladder diagram (LD) language program, and a function block diagram (FBD) language program. These are only examples, and are not intended to limit the disclosed or contemplated embodiments of the present invention. If there are any other engineering languages capable of being used in the embodiments of the present invention in actual applications, they shall also be within the scope of the present invention.

Before the compilation unit generates a plurality of automatic control subroutines according to an automatic control program, the automatic control program is output into an awl format file.

In the disclosed embodiments of the present invention, the main process by which the compilation unit generates a plurality of automatic control subroutines according to an automatic control program is: the compilation unit divides the automatic control program into segments and generates a symbol table, syntax tree and control flow graph based on semantic analysis, and generates a plurality of automatic control subroutines after determining the dependence relationships among the automatic control program segments.

Step S41: the operational support unit acquires the intermediate code of each of the automatic control subroutines and converts the intermediate code of each of the automatic control subroutines to tasks to be run in an embedded operating system, and after identifying each processing unit, sends each of the tasks to the corresponding processing unit.

In accordance with embodiments of the present invention, once the operational support unit has identified each processing unit, the operational unit sends each task to the corresponding processing unit according to the identity of each processing unit. For example, after separating the various automatic control subroutines, the order of execution of each automatic control subroutine is determined, while correspondingly, the identifier of each processing unit can reflect the order of execution, hence each task can be sent to the corresponding processing unit based on the identifiers of the processing units.

Step S42: at least two processing units separately receive the tasks sent by the operational support unit that correspond to the automatic control subroutines and run the same, and perform data communication with each other as they are run.

When the at least two processing units run the tasks corresponding to the automatic control subroutines, the operational support unit controls the at least two processing units to synchronously execute each task obtained through conversion of the intermediate code of each automatic control subroutine.

Preferably, the processing units perform data communication with each other based on the communication protocol adopted by the operational support unit, where the communication protocol adopted by the operational support unit is at least one of network protocol (IP) and data transmission protocol (UDP). These are only examples, and are not intended to limit the disclosed embodiments of the present invention. If there are any other communication protocols capable of being used in embodiments of the present invention in actual applications, they shall also be included within the scope of the present invention.

In accordance with embodiments of the present invention, the specific process by which the compilation unit divides the automatic control program into a plurality of automatic control subroutines is as follows:

First, the automatic control program is divided into segments, i.e., the automatic control program is divided into separate parts to obtain a number of automatic control program segments. In the industrial control standard programming language Electrotechnical Commission International (IEC) standard 61131-3 formulated by the IEC, an automatic control program written using an engineering language is composed of a number of networks. Therefore, the automatic control program is divided into segments taking a network as the grain size, i.e., each automatic control program segment is one network.

Next, a symbol table and a syntax tree are generated and a control flow graph (CFG) is constructed for each automatic control program segment based on semantic analysis.

A parallel model of the automatic control program is then established by analysing the dependencies among the automatic control program segments according to the syntax tree, symbol table and control flow graph of the automatic control program. The parallel model of the automatic control program should be capable of clearly showing the relationships among the components included in the automatic control program.

Finally, automatic control program segments represented by syntax tree nodes having close dependency are partitioned as one automatic control subroutine, while automatic control program sections represented by syntax tree nodes having loose dependency are partitioned into different automatic control subroutines.

In accordance with embodiments of the present invention, after analysing the dependence relationships among the various automatic control subroutines, synchronization operations among the various automatic control subroutines can be obtained, including the execution order of the various constituent parts of each automatic control subroutine, and data that require synchronization among the various processing units, etc. In this case, the compilation unit can automatically insert the codes for executing these synchronization operations at suitable locations in the corresponding automatic control subroutines.

In accordance with embodiments of the present invention, the operational support unit adopts a lightweight IP protocol stack, while at the same time screening numerous primitives specified in the MPI protocol, using only the six most basic primitives thereof for reference, in order to identify the processing units, control the execution of the parallel programs (for instance starting and ending), and define synchronization operations, i.e., before inserting synchronization operations in each of the automatic control subroutine sections respectively according to the dependence relationships among the various automatic control subroutine sections (it is necessary to pre-define message passing interface (MPI) primitives for identifying processing units), controlling the execution of parallel programs and defining synchronization operations. The foregoing includes defining MPI_Send( ) and MPI_Recv( ) primitives to accomplish data transfer from one processing unit to another, defining the MPI_Init( ) primitive to accomplish MPI initialization, defining the MPI_Comm_rank( ) primitive to determine the label of the invoking process, defining the MPI_Barrier( ) primitive to block execution until the end of synchronization, and defining the MPI_Gather( ) primitive to collect far-end inputs and outputs, and so on.

In accordance with embodiments of the present invention, the intermediate code is similar to the bytecode formed by compiling Java source code, being a universal language format suitable for use in programmable logic controllers (PLC).

Embodiments of the present invention will be described below taking a specific embedded multi-processor parallel processing system as an example.

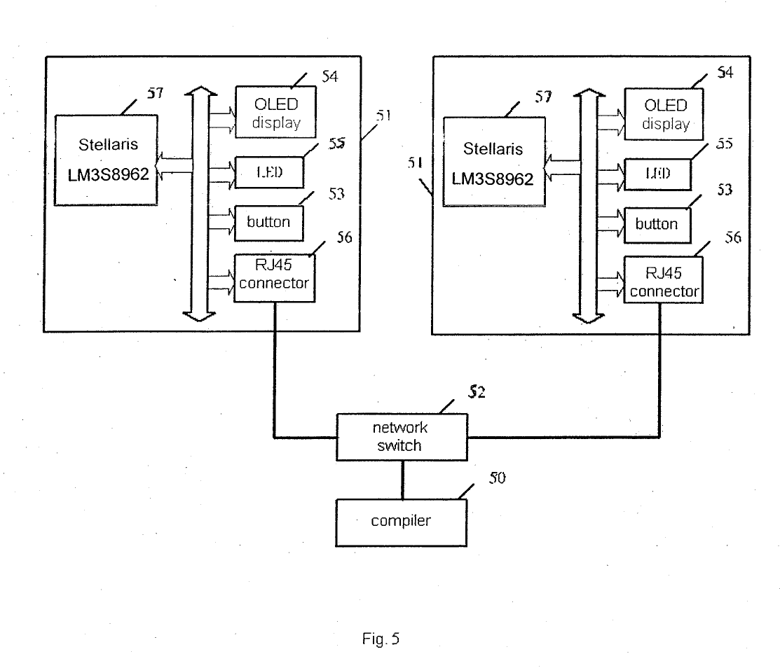

As shown in FIG. 5, the programmable logic controller (PLC) used by the compiler 50 is STEP7 Micro/Win, while the PLC used by the two processors 51 is Stelliaris LM3S8962, the two processors 51 and the compiler 50 being interconnected via a network switch 52, where the compiler 50 is equivalent to the compilation unit in the above embedded multi-processor parallel control system in accordance with embodiments of the present invention, each processor 51 is equivalent to each processing unit in the above embedded multi-processor parallel control system in accordance with embodiments of the present invention, and the operational support unit in the multi-processor parallel control system provided by the embodiments of the present invention is embedded in the compiler 50 and each processor 51.

The specific operating method of the system shown in FIG. 5 is as follows:

First, the compiler 50 outputs a control program (i.e., source file) written in STL into an awl format file, and based on this awl file divides the STL control program into a plurality of STL control subroutines, with one or more control subroutines corresponding to one processor 51, and compiles each STL control subroutine into PLC intermediate code.

Next, the PLC intermediate code obtained by compiling each STL control subroutine is converted to a task (binary file) to be run in an embedded operating system and sent to the corresponding controller 51. Alternatively, the PLC intermediate code is sent to the corresponding processor 51, and converted by the processor 51 to the corresponding task.

Finally, the two processors 51 simultaneously execute the obtained tasks corresponding to the STL control subroutines, where the two processors 51 perform data interaction via a network during execution.

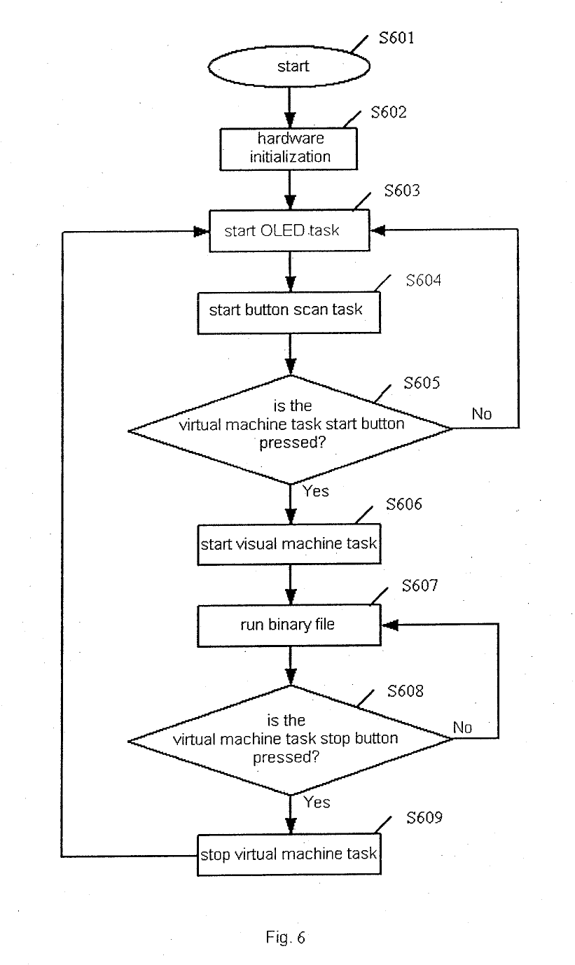

When a button 53, organic light-emitting diode (OLED) 54, light-emitting diode (LED) 55 and RJ45 network connector 56 are provided on the test board on which each processor 51 is located and connected to the Stelliaris LM3S8962 (PLC) 57 via a bus, the operational support unit embedded in the processor 51 is equivalent to a virtual machine. As shown in FIG. 6, the operating process of the test board on which each processor is located is as follows:

Step S601: the test board is started;

Step S602: hardware initialization is performed;

Step S603: start the OLED task;

Step S604: start a button scan task;

Step S605: judge whether the start button for the virtual machine task is pressed. If the start button is not pressed, then return to step S603 to re-start the OLED task, and if the start button is pressed, then perform step S606;

Step S606: start the virtual machine task;

Step S607: on the basis of the virtual machine task, execute the binary file obtained through conversion of the corresponding universal PLC intermediate code;

Step S608: judge whether the stop button for the virtual machine task is pressed. If the stop button is not pressed, then return to step S607 to cyclically execute the binary file obtained through conversion of the corresponding universal PLC intermediate code. If the stop button is pressed, then perform step S609; and

Step S609: stop the virtual machine task, and return to step S603 to re-start the OLED task.

Although embodiments of the present invention have been set forth and described, those skilled in the art will appreciate that a variety of changes, amendments, substitutions and alterations can be made to these embodiments without departing from the principles and aims of the present invention; the scope of the present invention is defined by the claims and equivalents thereof.

Thus, while there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An embedded multi-processor parallel processing system, comprising:
a compilation unit configured to generate a plurality of automatic control subroutines according to an automatic control program, and to compile each of the plurality of automatic control subroutines into intermediate code;
an operational support unit configured to acquire the intermediate code of each of the plurality of automatic control subroutines from the compilation unit and to convert the intermediate code of each of the plurality of automatic control subroutines to tasks to be run in an embedded operating system, and to identify each processing unit and send each of the tasks to be executed to a corresponding processing unit; and
at least two processing units for receiving and executing the tasks obtained through conversion of the intermediate code of the plurality of automatic control subroutines and sent by the operational support unit, each of the at least two processing units being configured to perform data communication with each other while executing tasks corresponding to the automatic control subroutines.

2. The system as claimed in claim 1, wherein the operational support unit is further configured to control the at least two processing units to synchronously execute each of the tasks obtained through conversion of the intermediate code of each of the plurality of automatic control subroutines.

3. The system as claimed in claim 1, wherein the automatic control program processed by the compilation unit is at least one of a structured text language program, a ladder diagram language program and a function block diagram language program.

4. The system as claimed in claim 1, wherein the operational support unit is further configured to perform data communication based on a communication protocol adopted by the operational support unit when the at least two processing units are executing tasks corresponding to the automatic control subroutines; and
wherein the communication protocol adopted by the operational support unit comprises at least one of a network protocol and a data transmission protocol.

5. The system as claimed in claim 1, wherein the compilation unit comprises:
a parallelization sub-unit configured to divide the automatic control program into segments and generate a symbol table, syntax tree and control flow graph based on semantic analysis, and to generate the plurality of automatic control subroutines after determining dependence relationships among the segments of automatic control program; and
a compilation sub-unit configured to compile each of the plurality of automatic control subroutines into the intermediate code.

6. The system as claimed in claim 5, wherein the compilation unit further comprises:
a pre-processing sub-unit configured to output the automatic control program into an awl format file.

7. An operating method for an embedded multi-processor parallel control system, comprising:
generating, by a compilation unit, a plurality of automatic control subroutines according to an automatic control program, and compiling each of the automatic control subroutines into intermediate code;
acquiring, by an operational support unit, intermediate code of each of the plurality of automatic control subroutines and converting the intermediate code of each of the plurality of automatic control subroutines to tasks to be run in an embedded operating system, and after identifying each processing unit, sending each of the tasks to a corresponding processing unit; and
separately receiving, by at least two processing units, each of the tasks sent by the operational support unit which correspond to each of the plurality of automatic control subroutines and running each of the separately received tasks, the at least two processing units performing data communication with each other during execution of the separately received tasks.

8. The method as claimed in claim 7, wherein, when the at least two processing units execute tasks corresponding to the automatic control subroutines, the operational support unit controls the at least two processing units to synchronously execute each of the tasks obtained through conversion of the intermediate code of each of the plurality of the automatic control subroutines.

9. The method as claimed in claim 7, wherein the automatic control program is at least one of a structured text language program, a ladder diagram language program and a function block diagram language program.

10. The method as claimed in claim 7, wherein the processing units perform data communication with each other based on a communication protocol adopted by the operational support unit; and
wherein the communication protocol adopted by the operational support unit comprises at least one of a network protocol and a data transmission protocol.

11. The method as claimed in claim 7, wherein the step of generating the plurality of automatic control subroutines according to the automatic control program comprises:
dividing the automatic control program into segments and generating a symbol table, syntax tree and control flow graph based on semantic analysis, and generating the plurality of automatic control subroutines after determining dependence relationships among the segments of the automatic control program.

12. The method as claimed in claim 11, further comprising:
outputting the automatic control program into an awl format file before the plurality of automatic control subroutines are generated according to the automatic control program.
